(19) United States
(12) Patent Application Publication
(10) Pub. No.: US 2002/0052243 A1
(43) Pub. Date: May 2, 2002

(54) Eccentric coupling

(76) Inventor: Enji Doisaki, Hyogo (JP)

Correspondence Address: ARMSTRONG,WESTERMAN & HATTORI, LLP, 1725 K STREET, NW., SUITE 1000, WASHINGTON, DC, 20006, US

(21) Appl. No.: 09/951,519

(22) Filed: Sep. 14, 2001

(30) Foreign Application Priority Data
Oct. 2, 2000 (JP) 2000-341171

(51) Int. Cl. F16D 3/48

(52) U.S. Cl. 464/137

(57) ABSTRACT

The present invention provides an eccentric shaft coupling capable of facilitating desirable power transmitting between drive and driven shafts disposed in one direction and in series with each other, with a sufficient durability and without any scooping even if the amount of eccentricity between respective axes of the shafts is changed or distributed. As shown in FIG. 1, an intermediate disc 5 is provided between a drive disc 3 and a driven disc 4 which are fixed to the opposed ends of a drive shaft 1 and a driven shaft 2 disposed in one direction in series with each other, respectively. A coupling mechanism is provided respectively between the drive and intermediate discs 3, 5 and between the driven and intermediate discs 4, 5. These coupling mechanisms are arranged to couple the adjacent discs with forming plural links of parallelogram having four joints so as to allow each of the drive and driven discs 3, 4 to be rotated in radius of a given dimension without any change in relative rotational angle with respect to the center of the intermediate disc 5. The combined two sets of coupling mechanisms can eliminate undesirable scooping between the drive and driven shafts 1, 2 for any dimension of eccentricity.

### BACKGROUND OF THE INVENTION

A conventional eccentric shaft coupling has been constructed with the use of a displacement-absorbing member made of rubber, flexible synthetic resin material or the like and interposed between the axes of two shafts for transmitting a rotational power in order to absorb a displacement, such as eccentricity or declination, arising between the axes of the two shafts. FIG. 9 shows one example thereof. The reference numeral 1 indicates a drive shaft, and the reference numeral 2 indicates a driven shaft. A drive disc 3 and a driven disc 4 are fixed to the ends of the drive and driven shafts as power transmission shafts, respectively. The reference numeral 100 indicates a coupling shaft for coupling the drive disc with the driven disc, and the coupling shaft is typically provided in a plural number. The reference numeral 101 indicates a displacement-absorbing member, which is typically provided in the same number as that of the coupling shafts 100. However, in case that a large eccentricity or declination is caused between the axes of the two rotational power transmission shafts, it is required to increase the flexibility of the displacement-absorbing member. This displacement-absorbing member having the increase flexibility is normally deficient in strength for a use condition. Conversely, the displacement-absorbing member provided with a larger strength normally has an excessive rigidity for a use condition. This involves undesirable high scooping force in connection with absorbing the displacement. Thus, in either case, such an eccentric shaft coupling has suffered from degraded durability.

An Oldham's coupling is known as an eccentric shaft coupling constructed without resorting to any displacement-absorbing member. FIG. 10 is an exploded perspective view of one example. The reference numeral 1 indicates a drive shaft, and the reference numeral 2 indicates a driven shaft. A drive disc 102 and a driven disc 103 are fixed to the ends of the drive and driven shafts serving as power transmission shafts, respectively. An intermediate disc 104 is disposed between the drive disc 102 and the driven disc 103. The intermediate disc has one end face opposed to the drive disc 102 and the other end face opposed to the driven disc 103. The one end face and the other end face are formed with a rectangle groove 105 and a rectangular groove 106 disposed in orthogonal relationship to each other, respectively. The drive disc 102 and the driven disc 103 are provided with a raised portion 107 and a raised portion 108, respectively. The raised portions 107 and 108 are arranged to fit into the groove 105 and the groove 106, respectively. The amount of eccentricity between the shafts is absorbed by a relative slide between the grooves and the raised portions which are fitted with each other. However, such an Oldham's coupling has a disadvantage for intensive abrasion arising from insufficient lubrication due to a scattering phenomenon of lubricant caused by centrifugal force.

### SUMMARY OF THE INVENTION

The present invention relates to a coupling for transmitting a rotational power between two shafts disposed in one direction and in series with each other in case that the respective axes of the shafts have an eccentricity, declination, or combination of eccentricity and declination.

Particularly, the present invention provides a shaft coupling having a sufficient durability without resorting to any displacement-absorbing member or Oldham's coupling in order to absorb a displacement, such as eccentricity or declination, between the axes of two shafts for transmitting a rotational power.

### BRIEF DESCRIPTION OF DRAWINGS

FIG. 1 is a front view of a shaft coupling according to a first embodiment of the present invention, wherein a coupling bearing is composed of a slide bearing.

FIG. 2 is a sectional view taken along the line of FIG. 1.

FIG. 3 is an enlarged view showing the relationship between the respective centers of a drive disc, driven disc and intermediate disc according to the first embodiment.

FIG. 4 illustrates a basic principle for providing a synchronous rotational state with the same rotational angle between a drive disc and driven disc of the present invention.

FIG. 5 is a sectional view of a shaft coupling according to a second embodiment of the present invention, wherein a coupling bearing is composed of a slide bearing.

FIG. 6 is a front view of a shaft coupling according to another embodiment of the present invention, wherein the coupling bearing according to the first embodiment is substituted with a rolling bearing.

FIG. 7 is a sectional view taken along the line of FIG. 6.

FIG. 8 is a sectional view of a shaft coupling according to another embodiment of the present invention, wherein the coupling bearing according to the second embodiment is substituted with a rolling bearing.

FIG. 9 is a side view of a conventional shaft coupling in which an axial eccentricity or declination is absorbed by a displacement-absorbing member.

FIG. 10 is an exploded perspective view of a conventional Oldham's coupling.

In the above figures, each element is indicated by a given reference numeral as follows. 1: drive shaft, 2: driven shaft, 3: drive disc, 4: driven disc, 5: intermediate disc, 6: coupling bearing, 7: coupling shaft, 8: bearing outer ring, 9: bearing inner ring, 10: seal, 11: seal, 12: snap ring, 13: snap ring, 14: coupling bearing, 15: coupling shaft, 16: bearing outer ring, 17: bearing inner ring, 18: seal, 19: seal, 20: snap ring, 21: snap ring, 22: coupling bearing, 23: coupling shaft, 24: bearing outer ring, 25: bearing inner ring, 26: seal, 27: seal, 28: snap ring, 29: coupling bearing, 30: coupling shaft, 31: bearing outer ring, 32: bearing inner ring, 33: seal, 34: seal, 35: snap ring, 36: coupling bearing, 37: coupling shaft, 38: bearing outer ring, 39: bearing inner ring, 40: roller, 41: roller, 42: seal, 43: seal, 44: coupling bearing, 45: coupling shaft, 46: bearing outer ring, 47: bearing inner ring, 48: roller, 49: roller, 50: seal, 51: seal, 60: coupling bearing, 61: coupling shaft, 62: bearing outer ring, 63: bearing inner ring, 64: roller, 65: spherical roller, 66: seal, 67: coupling bearing, 68: coupling shaft, 69: bearing outer ring, 70: bearing inner ring, 71: roller, 72: spherical roller, 73: seal, 100: coupling shaft, 101: displacement-absorbing member, 102: drive disc, 103: driven disc, 104: intermediate disc, 105: drive-disc-side groove of intermediate disc, 106: driven-disc-side groove of intermediate disc, 107: raised portion of drive disc, and 108: raised portion of driven disc.

### DETAILED DESCRIPTION OF THE INVENTION

A shaft coupling of the present invention comprises: a pair of discs composed of a drive disc and a driven disc each of which has a boss, wherein the boss of the drive disc and the boss of the driven disc are fixed to the end of a drive shaft and the end of a driven shaft opposed to each other, respectively, and the drive shaft and driven shaft are arranged in one direction and in series with each other; an intermediate disc disposed between the drive disc and the driven disc; and two sets of coupling mechanisms in which one of the coupling mechanisms is provided between the drive disc and the intermediate disc and the other of the coupling mechanisms is provided between the driven disc and the intermediate disc. These coupling mechanisms are constructed to couple each of the drive and driven discs with the intermediate disc so as to allow each of the drive and driven discs to be rotated in radius of a given dimension without any change in relative rotational angle therebetween due to the parallelogram-link function and to allow a desired power to be transmitted despite of any amount of displacement between the drive and driven shafts without any scooping.

Further, in the above shaft coupling, in case that the axes of the drive and driven shafts arranged in one direction and in series with each other are not parallel, a spherical bearing is employed in the coupling mechanisms.

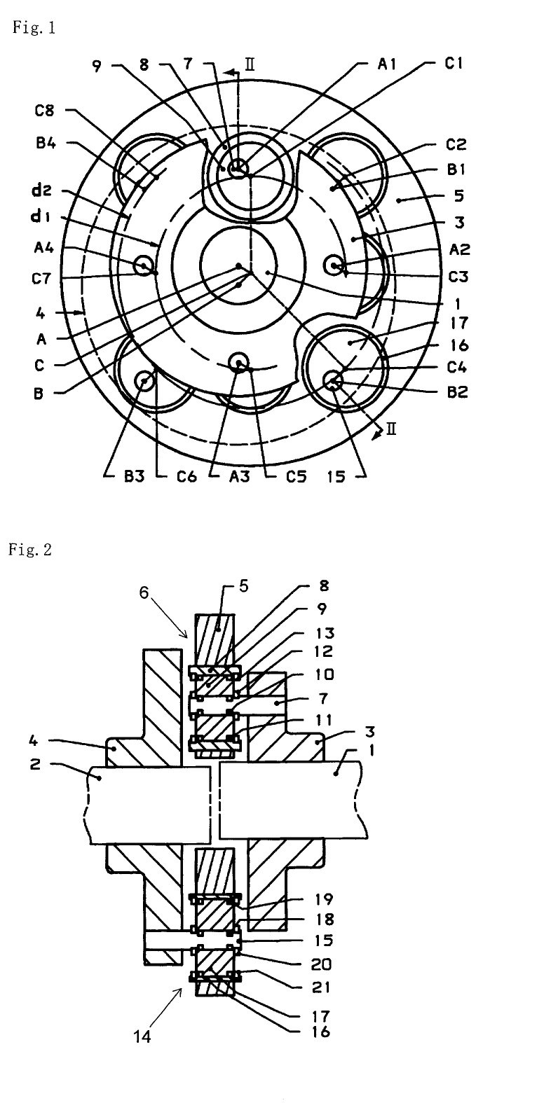

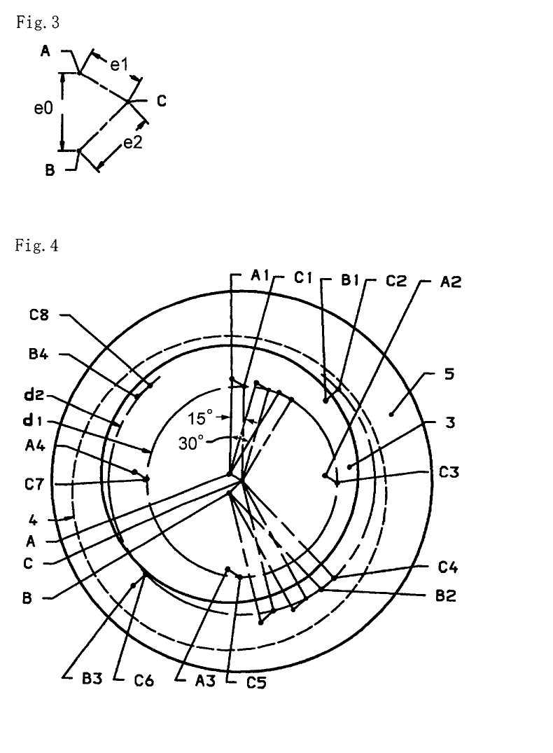

Various embodiments of the present invention will now be described. FIG. 1 is a front view showing a shaft coupling according to a first embodiment of the present invention. FIG. 2 is a sectional view taken along the line of FIG. 1. This shaft coupling includes a pair of discs composed of a drive disc 3 and a driven disc 4 each having a boss. The boss of the drive disc 3 and the boss of the driven disc 4 are fixed to the end of a drive shaft 1 and the end of a driven shaft 2 opposed to each other, respectively. The drive and driven shafts 1, 2 are arranged in one direction and in series with each other, and the respective axes of the drive and driven shafts are arranged in parallel with each other. The shaft coupling further includes an intermediate disc 5 disposed between the drive disc 3 and the driven disc 4, and two sets of coupling mechanisms. One set of the coupling mechanisms is provided between the drive disc 3 and the intermediate disc 5, and the other set of the coupling mechanisms is provided between the driven disc 4 and the intermediate disc 5. Each set of the coupling mechanisms includes a plurality of coupling bearings. Each of the coupling bearings comprises a single coupling shaft and a single bearing section having an inner periphery (inner diameter) allowing the outer periphery (outer diameter) of one end of the coupling shaft to be fitted thereinto. In this bearing section, the center of the outer diameter of an outer ring and the center of the inner diameter of an inner ring are decentered from each other by a given dimension.

The coupling mechanism between the drive disc 3 and the intermediate disc 5 is constructed as follows. A first plurality of holes are formed in the boss of the drive disc 3 at even intervals on a circle having a diameter dl with a center at the center of the boss of the drive disc 3. A second plurality of holes having the same number as that of the first holes are formed in the intermediate disc 5 at even intervals on a circle having a diameter d1 with a center at the center of the intermediate disc 5. The outer periphery of one end of a coupling shaft 7 of a coupling bearing 6 is fixedly fitted into each of the first (or second) holes formed in of the drive disc 3 (or intermediate disc 5) at even intervals on the circle having the diameter d1 of the drive disc 3 (or intermediate disc 5). The outer periphery of a bearing outer ring 8 at the other end of the coupling bearing 6 is fixedly fitted into each of the second (or first) holes formed in the intermediate disc 5 (or drive disc 3) at even intervals on the circle having the diameter dl of the intermediate disc 5 (or drive disc 3). The second (or first) holes have the same number as that of the first (or second) holes. In the coupling bearing 6, the given dimension of eccentricity between the center of the outer diameter of the bearing outer ring 8 and the center of the inner diameter of a bearing inner ring 9 is defined as e1. In the same manner as the coupling mechanism between the drive disc 3 and the intermediate disc 5, the coupling mechanism between the driven disc 4 and the intermediate disc 5 is constructed, where the diameter of a circle for arranging thereon respective fixing holes formed in the driven disc 4 and the intermediate disc 5 at even intervals is defined as d2, and a given dimension of eccentricity between the center of the outer diameter of a bearing outer ring 16 and the center of the inner diameter of a bearing inner ring 17 in a coupling bearing 14 having a coupling shaft 15 fitted thereinto is defined as e2. Respective circles of the diameter dl and the diameter d2 on the intermediate disc 5 are concentric.

In the coupling bearing 6, a seal 10 and a seal 11 each for retaining lubricant are disposed between the coupling shaft 7 and the bearing inner ring 9 and between the bearing outer ring 8 and the bearing inner ring 9, respectively. In the coupling bearing 14, a seal 18 and a seal 19 each for retaining lubricant are disposed between the coupling shaft 15 and the bearing inner ring 17 and between the bearing outer ring 16 and the bearing inner ring 17, respectively. These seals prevent the scattering of lubricant. Snap rings 12, 13, 20 and 21 are provided for preventing the coupling bearings 6 and 14 from dropping out in the axial direction.

In the figures, each small component, such as seals and snap rings, is illustrated in an exaggerated form simply for the purpose of their distinctness. The snap ring at each portion indicated by the description “fixed” or “fixedly fitted” is omitted.

In FIGS. 1 and 2, the coupling shaft 7 of the coupling bearing 6 has been fixed to the drive disc 3 or the intermediate disc 5, and the coupling shaft 15 of the coupling bearing 14 has been fixed to the driven disc 4 or the intermediate disc 5. However, the present invention is not limited to the shaft and disc prepared as separated parts, and an integrally formed part (not shown) may be used to provide a downsized shaft coupling having enhanced strength.

In the embodiment shown in FIG. 1, each of the coupling mechanisms between the drive disc 3 and the intermediate disc 5 and between the driven disc 4 and the intermediate disc 5 includes four of the coupling bearings. These bearings are provided in the intermediate disc 5. Each point A1, A2, A3, A4 indicates each center of the coupling shafts fixed to the drive disc 3, and each point C1, C3, C5, C7 indicates each outer diameter center of the outer rings fixed to the intermediate disc 5, wherein the length of segment A1 C1=the length of segment A2 C3=the length of segment A3 C5=the length of segment A4 C7=e1. Each point B1, B2, B3, B4 indicates each center of the coupling shafts fixed to the driven disc 4, and each point C2, C4, C6, C8 indicates each outer diameter center of the outer rings fixed to the intermediate disc 5, wherein the length of segment B1 C2=the length of segment B2 C4=the length of segment B3 C6=the length of segment B4 C8=e2.

In FIGS. 1 and 2, each dimension of e1 and e2 is illustrated in an exaggerated form to clarify an affect of eccentricity.

Given that the dimension of eccentricity between the drive shaft center and the driven shaft center is e0, the values e1 and e2 are determined to satisfy a formula e1−e2 e0 e1+e2. The shaft coupling having the determined values e1 and e2 can transmit a desirable rotational power without any scooping even if the value e0 is changed or distributed within the range of the above formula. The term “change” herein means that the eccentricity dimension e0 is changed as each shaft in the set of the drive and driven shafts is rotated. The term “distribution” herein means that when the set of the drive and driven shafts is one of products produced through mass production lines, the eccentricity dimension e0 is scattered in a certain range due to the unevenness of dimensional accuracy in each product. When e1=e2=e is satisfied, the eccentricity dimension e0 can change or distribute within the range of 0 e0 2e.

In FIG. 1, the axis of the drive shaft 1 and the axis of the driven shaft 2 are projected to locate them at a single point A and a single point B, respectively. Thus, when a point C is determined to satisfy the length of segment AC=e1 and the length of segment BC=e2, the point C will be matched with the center of the intermediate disc 5. Further, when each position of the points A and B are fixed, the position of the point C will also be fixed. The relationship between the points A, B and C is shown as an enlarged view in FIG. 3.

When the drive shaft 1 is rotated with a center at the point A, the intermediate disc 5 is rotated with a center at the point C by the same rotational angle in sync with the drive shaft 1. Then, the driven shaft 2 is rotated with a center at the point B by the same rotational angle in sync with the intermediate disc 5.

FIG. 4 shows a principle of the synchronous rotation with the same rotational angle. For clarifying the figure, FIG. 4 shows only the outer diameter lines and centers of the drive disc 3, driven disc 4 and intermediate disc 5, the outer diameter center of the outer ring in the coupling bearings, the center of the coupling shaft and the concentric circles of the diameters d1 and d2 on the intermediate disc 5 abstracted from FIG. 1. FIG. 4 shows the state when the drive disc is rotated by a rotational angle of 15-degree and 30-degree.

The reason why the synchronous rotation with the same rotational angle is achieved between the drive disc 3 and the intermediate disc 5 and between the driven disc 4 and the intermediate disc 5 will be described as follows. Given that the point A1 is the center of the fixing hole in the drive disc 3 for any one of the coupling bearings 6 coupling between the drive disc 3 and the intermediate disc 5, and the point C1 is the center of the fixing hole in the intermediate disc 5 for said coupling bearing, the following equality is satisfied; the length of segment A C=the length of segment A1 C1=e1, and the length of segment A A1 =the length of segment C C1=d½. This means that the quadrangle A A1 C1 C is a parallelogram. Thus, when the segment A A1 is rotated with a center at the point A, the segment C C1 is also rotated with a center at the point C with keeping the parallelogram. Consequently, the synchronous rotation with the same rotational angle is achieved.

Similarly, in the coupling mechanism between the driven disc 4 and the intermediate disc 5, given that the point B2 is the center of the fixing hole in the driven disc 4 for any one of the coupling bearings 14 coupling between the driven disc 4 and the intermediate disc 5, and the point C4 is the center of the fixing hole in the intermediate disc 5 for said coupling bearing, the following equality is satisfied; the length of segment B C=the length of segment B2 C4=e2, and the length of segment B B2=the length of segment C C4=d2/2 . As in the drive disc 3, the synchronous rotation with the same rotational angle is achieved between the driven disc 4 and the intermediate disc 5.

The shaft coupling of the present invention can transmit power in both positive and reverse rotational directions. With reference to FIG. 4, the relative sliding movement between the coupling shaft 7, the bearing outer ring 8 and the bearing inner ring 9 in the coupling bearing 6 when the drive disc 3 is rotated clockwise on the sheet of the figure will be described below. When the point A1 and the point C1 are rotated by 90-degree, 180-degree and 270-degree, these points reach the point A2 and the point C3, the point A3 and the point C5, and the point A4 and the point C7 at each rotated angle, respectively. Given that the point A1 is a head portion and the point A is a foot portion, the point C1 located at the lower right position with respect to the point A1 will be moved to the upper right position after rotated by 90-degree, to the upper left position after rotated by 180-degree, and to the lower left position after rotated by 270-degree. Thus, when the drive disc 3 is rotated clockwise by 360-degree, the point C1 is rotated about the point A1 counterclockwise by 360-degree. The coupling shaft 7 and the bearing outer ring 8 are fixed to the drive disc 3 and the intermediate disc 5, respectively. Further, the drive disc 3 and the intermediate disc 5 are constructed to move without any change of the relative rotational angle. Thus, a relative rotational movement is caused between the outer periphery of the coupling shaft 7 and the inner periphery of the bearing inner ring 9 and between the outer periphery of the bearing inner ring 9 and the inner periphery of the bearing outer ring 8.

FIGS. 1 and 2 show a relative sliding rotational movement. In the coupling mechanism between the intermediate disc 5 and the driven disc 4, when the intermediate disc 5 is rotated clockwise by 360-degree as with the case described above, the point C2 is rotated about the point B1 counterclockwise by 360-degree.

In the above description, the points A1, A2, A3 and A4 and the points C1, C3, C5 and C7 are located at even intervals on the respective circles of the diameter d1 with the respective centers at the center A of the drive disc 3 and the center C of the intermediate disc 5. However, in view of actual requirements, these points are not necessarily located at even intervals on the respective circles. If located at uneven intervals or deviated, each point corresponding to the deviated points (the points C1, C3, C5 and C7 correspond to the points A1, A2, A3 and A4, respectively) may be arranged at a geometrical relative position with respect to each of the centers A and C. In this case, the following equalities are satisfied; the length of segment A A1=the length of segment C C1, the length of segment A A2=the length of segment C C3, the length of segment A A3=the length of segment C C5, the length of segment A A4=the length of segment C C7, and the length of segment AC=the length of segment A1 C1=the length of segment A2 C3=the length of segment A3 C5 =the length of segment A4 C7=e1. This allows each of the quadrangles A A1 C1 C, A A2 C3 C, A A3 C5 C and A A4 C7 C to be a parallelogram. Thus, the synchronous rotation with the same rotational angle is achieved between the drive disc 3 and the intermediate disc 5.

In the exactly same manner, the relative sliding rotational movement of the points B1, B2, B3, and B4 and the points C2, C4, C6 and C8 can be explained with respect to the centers B of the driven disc 4 and the center C of the intermediate disc 5. Thus, the synchronous rotation with the same rotational angle is also achieved between the driven disc 4 and the intermediate disc 5.

FIG. 5 illustrates a shaft coupling according to a second embodiment of the present invention, wherein the fundamental structure is the same as that of the first embodiment shown in FIGS. 1 and 2. In FIG. 5, each of coupling bearings 22 and 29 is a slide bearing. The coupling bearing 22 comprises a coupling shaft 23, a bearing outer ring 24, a bearing inner ring 25, a lubricant seal 26, a lubricant seal 27, and a snap ring 28. The coupling bearing 29 comprises a coupling shaft 30, a bearing outer ring 31, a bearing inner ring 32, a lubricant seal 33, a lubricant seal 34, and a snap ring 35. A spherical surface may be selectably provided between the outer ring 24, 31 and the inner ring 25, 32 or between the inner ring 25, 32 and the coupling shaft 23, 30 to absorb the declination of the drive and/or driven shaft. FIG. 5 shows one example having a fitting portion between the outer ring and inner ring. Since the structure of FIG. 5 is the same as that of FIGS. 1 and 2 excepting the fitting portion including a spherical surface, any figure corresponding to FIG. 1 will be omitted.

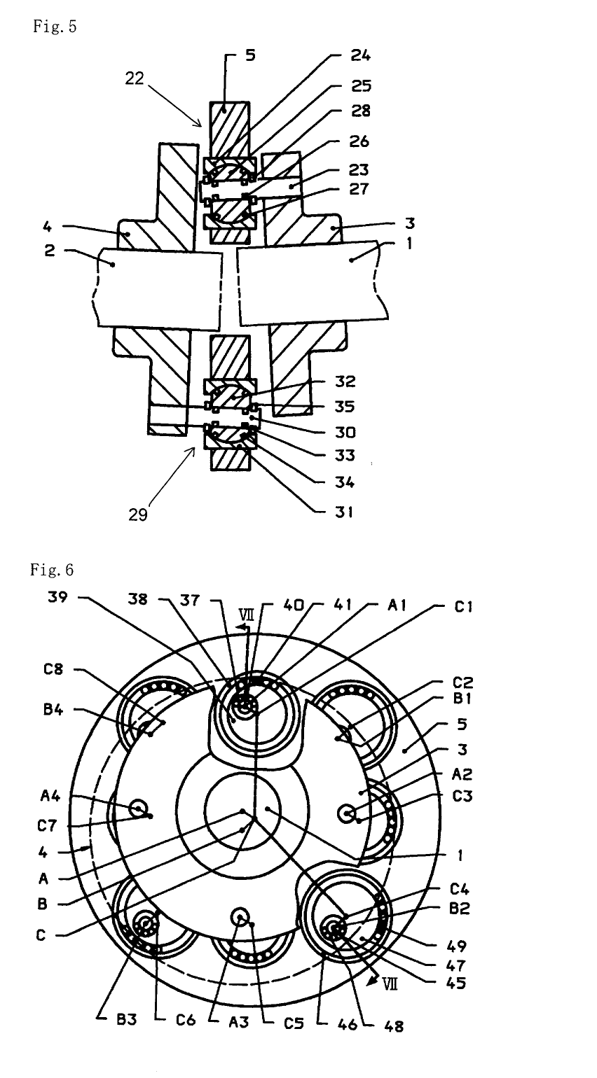

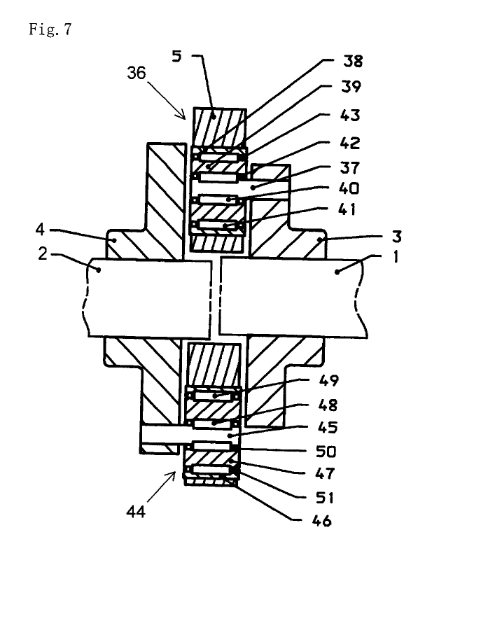

FIG. 6 is a front view of a shaft coupling according to another embodiment of the present invention. In the coupling bearing of the first embodiment, each relative rotational movement between the outer periphery of the coupling shaft and the inner periphery of the bearing inner ring and between the outer periphery of the bearing inner ring and the inner periphery of the bearing outer ring is changed into a rolling movement according to a roller. FIG. 7 is a sectional view of FIG. 6. The structure of this embodiment is the same as that of FIGS. 1 and 2 excepting a rolling bearing used as a coupling bearing 36, 44. Thus, the coupling bearing 36 comprises a coupling shaft 37, a bearing outer ring 38, a bearing inner ring 39, a roller 40 provided between the coupling shaft 37 and the inner ring 39, a roller 41 provided between the inner ring 39 and the outer ring 38, a lubricant seal 42, and a lubricant seal 43. The coupling bearing 44 comprises a coupling shaft 45, a bearing outer ring 46, a bearing inner ring 47, a roller 48 provided between the coupling shaft 45 and the inner ring 47, a roller 49 provided between the inner ring 47 and the outer ring 46, a lubricant seal 50, and a lubricant seal 51. In these figures, each small component, such as seals and rollers, is illustrated in an exaggerated form simply for the purpose of their distinctness. Since their functions are the same as those of the embodiment in FIGS. 1 and 2, their description will be omitted.

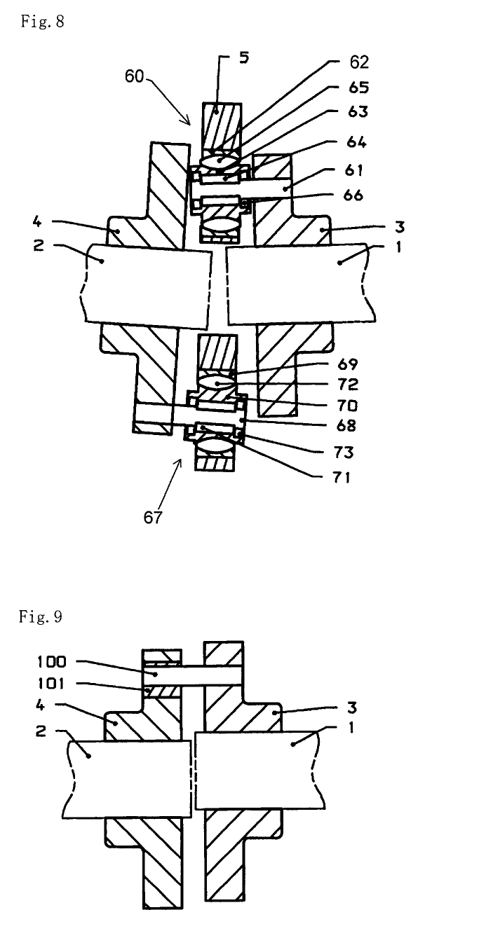

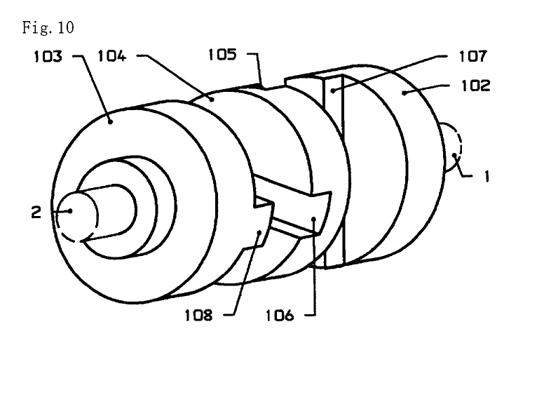

FIG. 8 shows a shaft coupling according to another embodiment of the present invention. In the coupling bearing of the second embodiment, each relative rotational movement between the outer periphery of the coupling shaft and the inner periphery of the bearing inner ring and between the outer periphery of the bearing inner ring and the inner periphery of the bearing outer ring is changed into a rolling movement according to a roller. The structure of this embodiment is the same as that of FIG. 5 excepting a rolling bearing used as a coupling bearing 60, 67. Thus, the coupling bearing 60 comprises a coupling shaft 61, a bearing outer ring 62, a bearing inner ring 63, a roller 64 provided between the coupling shaft 61 and the inner ring 63, a spherical roller 65 provided between the inner ring 63 and the outer ring 62, and a lubricant seal 66. The coupling bearing 67 comprises a coupling shaft 68, a bearing outer ring 69, a bearing inner ring 70, a roller 71 provided between the coupling shaft 68 and the inner ring 70, a spherical roller 72 provided between the inner ring 70 and the outer ring 69, and a lubricant seal 73. Since the functions in this embodiment are the same as those of the embodiment in FIG. 5, their description will be omitted.

According to the shaft coupling of the present invention, any eccentricity or declination between the axes of the drive and driven shafts can be absorbed without providing any displacement-absorbing member (rubber or flexible synthetic resin material) between the two shafts and without any abrasion due to insufficient lubrication to achieve desirable power transmission without any undesirable scooping.

What is claimed is:

1. A shaft coupling comprising:
a pair of discs composed of a drive disc and a driven disc each including a boss, wherein said drive disc is disposed on the side of a drive shaft, said driven disc being disposed on the side of a driven shaft, said boss of said drive disc and said boss of said driven disc being fixed to the opposed ends of said drive shaft and driven shaft, respectively, said drive and driven shafts being arranged in one direction and in series with each other and having parallel axes;
an intermediate disc disposed between said drive and driven discs; and
two sets of coupling mechanism disposed between said drive and intermediate discs and between said driven and intermediate discs, respectively, wherein
each of said coupling mechanism includes a plurality of coupling bearings identical to each other,
each of said coupling bearings including a single coupling shaft and a single bearing section having an inner periphery into which the outer periphery of said coupling shaft is fitted,
said bearing section including a bearing outer ring and a bearing inner ring, the center of the outer periphery of said bearing outer ring being eccentric with respect to the center of the inner periphery of said bearing inner ring by a given dimension,
said drive disc including a first plurality of holes dispersedly disposed substantially evenly on the surface of said drive disc with a center at a second hole provided in said boss of said drive disc to fit with said drive shaft,
said intermediate disc including a third plurality of holes having the same number as said first holes, each of said third holes being disposed with a center at the center of said intermediate disc and at a position geometrically corresponding to each of said first holes to be paired with one of said first holes, wherein said paired first hole and third hole are fitted with the outer periphery of the end of said coupling shaft and the outer of said bearing outer ring in each of said coupling bearings having the same number as the first or third holes.
said driven disc including a fourth plurality of holes dispersedly disposed substantially evenly on the surface of said driven disc with a center at a fifth hole provided in the boss of said driven disc to fit with said driven shaft, and
said intermediate disc including a sixth plurality of holes having the same number as said fourth holes, each of said sixth holes being disposed with a center at the center of said intermediate disc and at a position geometrically corresponding to each of said fourth holes to be paired with one of said fourth holes, wherein said paired fourth hole and sixth hole are fitted with the outer periphery of the end of said coupling shaft and the outer of said bearing outer ring in each of said coupling bearings having the same number as said fourth or sixth holes.

2. A shaft coupling in which the drive and driven shafts arranged in one direction and in series and having parallel axes in the shaft coupling as defined in claim 1 is substituted with drive and driven shafts arranged in one direction and in series and having non-parallel axes, characterized in that the bearing section of the shaft coupling as defined in claim 1 is a spherical bearing.
